(19) United States
(12) Patent Application Publication
(10) Pub. No.: US 2012/0096486 A1
(43) Pub. Date: Apr. 19, 2012

(54) METHOD AND SYSTEM FOR MANAGING TELEVISION ADVERTS IN TIME SHIFTED BROADCAST CONTENT

(76) Inventors: Paul Stallard, Southampton (GB); Jenny Bridges, Southampton (GB); Chris Mcevilly, Southampton (GB)

(21) Appl. No.: 13/262,721

(22) PCT Filed: Apr. 1, 2009
(86) PCT No.: PCT/EP2009/053906

§ 371 Date: Dec. 20, 2011

(51) Int. Cl. H04N 7/10

(52) U.S. Cl. 725/32

(57) ABSTRACT

There is provided a method of removing or replacing advert slots in linear broadcast television programming when replayed as a time-shifted television asset, comprising capturing an input linear broadcast video stream to form a time-shifted television asset, detecting advert cue signals indicative of advert slot timings within the time-shifted television asset, generating metadata indicative of the advert slot timings from the detected advert cue signals, and packaging the time-shifted television asset together with the metadata, for use by a downstream system to replace or remove adverts from the time-shifted television asset. There is also provided a time-shifted television asset capture device, comprising a linear broadcast video stream input, an advert cue signal detector to detect advert cue signals, a metadata generator adapted to generate metadata from the detected advert cue signals, and a metadata and time-shifted television asset packager adapted to package the metadata and time-shifted television asset together for delivery to a downstream system.

### TECHNICAL FIELD

The invention is related to advert management in general, and in particular to advert management in Time-shifted Television asset capture and playback.

### BACKGROUND

The advert industry underpins much of today's TV output. Currently, TV adverts are predominantly used in linear (broadcast) television. The broadcasters sell advertising slots (also known as ‘avails’) to advertising brokers, who in turn sell the advert slots to advertisers wishing to place TV adverts, or to advertisers directly.

Advert slots are characterized by the time of day at which they are played and the expected demographics of the programming around the advert slot. Where the broadcast infrastructure allows for regional variations, the advert slot characterization includes a region.

In Europe and Asia, the predominant model is for broadcasters to sell all advertising space and for operators (cable TV, satellite TV, or IPTV providers) to simply pass through the channels including the already filled advertising space.

However, in North America in particular, there is a vibrant regional advert insertion market that is managed by the operators, often a local cable TV company. The broadcasters still insert national advertising, but make a small number of advert slots available for local advert insertion. If the operator has managed to sell an advert slot to a local advertiser, the national adverts in those limited advert slots can be replaced with the local advertisement.

Historically, these advertising slots were marked in-band using an audio cue tone. The audio cue tone was the signal to the downstream system to switch in a local advertisement. The Society of Cable Telecommunications Engineers (SCTE) has created a digital equivalent of the audio cue tones, described in the specification SCTE 35. Although the digital cue tone is the predominant form of signalling for digitally encoded content, analogue cue tones and other more manual methods are still in use today, such as General Purpose Interface (GPI) contact closures.

Video-On-Demand (VOD) is a very successful new service offered by many operators across the world, because it provides a more bespoke programming experience to the end viewer/consumer.

VOD provides a new opportunity for advertising, as a VOD session is one-to-one and the identity of the subscriber is known. Therefore, there is the potential to target adverts directly to the subscriber. Targeted adverts command a higher price than non-targeted ads.

One of the most popular services offered on VOD is “catch up TV”, also known as ‘delay TV’, ‘start over’, ‘pick of the week’, and a variety of other operator-specific terms. These are all referred to here using the generic term of Time-shifted Television (TSTV), where TSTV assets, i.e. the individual programmes and their associated data, are required to populate TSTV offerings by the TV operators. TSTV is a sub-category of Video-On-Demand.

A general concept of TSTV is to make broadcast TV content available on-demand after (or sometimes during) the original broadcast. Some broadcasters deliver separate TSTV assets of their broadcast programming directly to the operator, ready for play out. However, where this has not been done, operators must use a dedicated TSTV asset capture solution to capture the broadcast content off the original broadcast stream.

However, when advertising-supported broadcast TV is captured by the broadcaster to produce a TSTV asset, it will contain the original broadcast adverts. This is not ideal, not only because some adverts have a limited lifetime and may become out of date and irrelevant during the time the asset is available on TSTVNOD, but also there is an opportunity to increase broadcaster/operator revenue by replacing these adverts with more relevant, targeted, higher-value adverts. There are also VOD/TSTV implementations that justify per programme payment by removing adverts from the VOD/TSTV version, which is often viewed as an appealing service to customers/viewers.

An example of a prior art TSTV capture system 100 is shown in FIG. 1, where linear broadcast TV 101 is inputted together with the broadcast schedule 102 in to the TSTV capture solution 103. Here, an editor 105 captures the TSTV asset from the off air broadcast (either manually, or automatically), and then may edit the raw TSTV asset to tidy up end points, and to replace adverts manually, as required. The delay between capture of the raw TSTV asset and delivery of a final edited TSTV asset is represented by delay 104. Data about the individual program within the TSTV asset (limited to that provided by the broadcast schedule) may be provided together with the TSTV asset itself, in the form of VOD packages 106, for storage onto a VOD delivery platform 107.

However, current TSTV capture solutions do not provide an automated mechanism for operators to characterise TSTV assets, including advert slots. Instead this must be done manually, which is time consuming, therefore it is not done or it is only carried out for a certain (often the most popular) sub-section of programming. Thus, broadcasters and operators are failing to realize the potential of replacing adverts in TSTV/VOD content. Furthermore, the information required to offer these advertising slots to advertisers is not available.

### SUMMARY

Embodiments of the present invention provide a method of removing or replacing advert slots in linear broadcast television programming when replayed as a time-shifted television asset, comprising capturing an input linear broadcast video stream to form a time-shifted television asset, detecting advert cue signals indicative of advert slot timings within the time-shifted television asset, generating metadata indicative of the advert slot timings from the detected advert cue signals, and packaging the time-shifted television asset together with the metadata, for use by a downstream system to replace or remove adverts from the time-shifted television asset.

Optionally, the advert cue signals include any one or more of
a. SCTE-35 messages
b. Dual-Tone Multi-Frequency (DTMF) cue tones
c. High/low frequency audio cue tones
d. High/low volume audio cue tones
e. Visual cues, e.g. IBA (Independent Broadcasting Authority) cue mark
f. External triggers such as GPI contact closures (i.e. physical external switching)
g. VANC (Vertical Ancilliary Data Space)
h. Other signals or communications as agreed between the broadcaster and a turnaround operator

Optionally, the method further comprises removing adverts prior to or at the time of playback of the time-shifted television asset to an end viewer, dependent upon the metadata generated from the detected advert cue signals.

Optionally, the method further comprises replacing an original advert with one or more alternative adverts, prior to or at the time of playback of the time-shifted television asset to an end viewer dependent upon the metadata generated from the detected advert cue signals.

Optionally, the metadata is XML metadata, and the metadata further includes programme characterisation information derived from a broadcast schedule associated with the linear broadcast television programming.

Optionally, the advert slot timings are outputted as SCTE 35 messages accompanying the time-shifted television asset.

Optionally, the step of capturing an input linear broadcast video stream further comprises importing a broadcast schedule, and generating a capture timetable from the imported broadcast schedule.

Optionally, the step of generating metadata indicative of the advert slot timings from the detected advert cue signals further comprises pre-generating metadata from the imported broadcast schedule prior to capture of the broadcast stream, indicative of programme data excluding advert slot timings, and updating the pre-generated metadata with metadata indicative of the detected advert cue signals after detection.

Optionally, the method further comprises generating a time-shifted advert inventory characterising each advert slot available within each time-shifted television asset available for playback within a Video-On-Demand playback system.

Embodiments of the present invention also provide a time-shifted television asset capture device, comprising a linear broadcast video stream input, an advert cue signal detector to detect advert cue signals, a metadata generator adapted to generate metadata from the detected advert cue signals, and a metadata and time-shifted television asset packager adapted to package the metadata and time-shifted television asset together for delivery to a downstream system.

Optionally, the time-shifted television asset capture device is adapted to carry out the aforementioned method.

Optionally, the time-shifted television asset capture device further comprises a GPI contact input, to allow detection of GPI contact closure based advert cue timing signals

Embodiments of the invention also provide a computer-readable medium, carrying instructions, which, when executed, causes computer logic to carry out any of described methods.

Embodiments of the invention also provide a method of producing an inventory of advert slots within a collection of time-shifted television assets, comprising receiving data about a content of a captured time-shifted television asset within the collection of time-shifted television assets, combining the received data into a predetermined structure with data on other time-shifted television assets within the collection of time-shifted television assets, and outputting an updated advert slot inventory in a predetermined data structure to a downstream system.

Optionally, the step of receiving data about content of a captured time-shifted television asset further comprises receiving a programme information data portion, providing details of a programme contained within a time-shifted television asset, including one or more of: a title of the TSTV asset; a genre, as classified by the content owner, aggregator or operator; a date range when the TSTV asset will be available for viewing; an age certification of the TSTV asset; and an advert slot timing information portion.

Optionally, the advert slot timing information comprises any one or more of: timecode of a start point of an advert slot; timecode of an end point of an advert slot; duration of an advert slot; type of an advert slot, wherein the type comprises any one of pre-roll, post-roll or interstitial.

Optionally, the step of receiving data about content of a captured time-shifted television asset further comprises receiving data from an external information source about the time-shifted television asset.

Embodiments of the present invention also provide a time-shifted television advert slot inventory generator adapted to generate an inventory of advert slots available in a catalogue of time-shifted television assets, including characterisations of a type of time-shifted television asset, for use by a downstream system, comprising an input for receiving data on captured time-shifted television assets, a processor for combining received data on captured time-shifted television assets into a predetermined data structure, and an output for exporting a completed advert inventory in a predetermined data structure to a downstream system.

Optionally, the input for receiving data on captured time-shifted television assets further comprises a programme information data portion, providing details of a programme contained within a time-shifted television asset, including one or more of: a title of the TSTV asset; a genre, as classified by the content owner, aggregator or operator; a date range when the TSTV asset will be available for viewing; an age certification of the TSTV asset; and an advert slot timing information portion.

Optionally, the input for receiving data on captured time-shifted television assets further comprises an external information system input, for receiving data on time-shifted television assets from systems external to a time-shifted television asset playback system.

Optionally, a downstream system is a sales function, time-shifted television server or time-shifted television advert replacement system.

Accordingly, there is provided a method and apparatus that will detect advert markers in a linear broadcast stream, or that will read external triggers such as General Purpose Interface (GPI) contact closures, and translate them into eXtensible Markup Language (XML) metadata about the respective captured TSTV assets. The XML metadata can then be used by an advert removal or insertion portion of an overall VOD system to replace or remove the adverts from the TSTV asset.

Alternately, or in addition, since adverts delineate traditional advertising sponsored TV programmes, the same apparatus and portions of the method may also be used by a TSTV capture system accurately to capture live broadcast programming for use as TSTV assets, which automatically takes into account cumulative program delays, such as found after coverage of live sporting events that have overrun.

Furthermore, there are also provided methods and apparatus that provide an advert inventory that characterises advert slots available within captured TSTV assets more accurately than previously available. In this way, the described advert inventory generator provides an enhanced inventory of advertising slots to potential buyers, which increases the marketability of the advert slots within the TSTV asset library.

The TSTV assets are typically packaged up into VOD packages including programme metadata, and the TSTV video asset itself.

The inventory may be generated automatically using information that is derived from analysing incoming information available to the VOD provisioning system, such as the linear broadcast feed and received broadcasting schedules. In particular, the linear broadcast advert detector methods and apparatus may be used within such an advert inventory generator portion of an overall VOD system to provide the advert slot timing information portion of the characterisation information provided by the advert inventory generator.

Embodiments of the present invention enable the automatic and accurate detection of adverts and their replacement with adverts that can be personalised to the end viewer/customer. Uses of advert slot timing date include: Removal of adverts from TSTV asset; Replacement of original advert with one or more new adverts, for example, because original advert is too out of date or the program was originally broadcast pre-watershed, but now it is being played back post watershed (therefore adverts suitable only for older viewers may be used), and vice versa.

Embodiments of the present invention also enable the accurate capture of time-shift TV content, thus removing the need for manual editing of this content and/or enhancing the customer experience.

### BRIEF DESCRIPTION OF THE DRAWINGS

Methods and apparatuses for managing adverts in Time-shifted Television will now be described, by way of example only, and with reference to the accompanying drawings in which:

FIG. 1 shows a schematic block diagram of a TSTV capture solution according to the prior art;

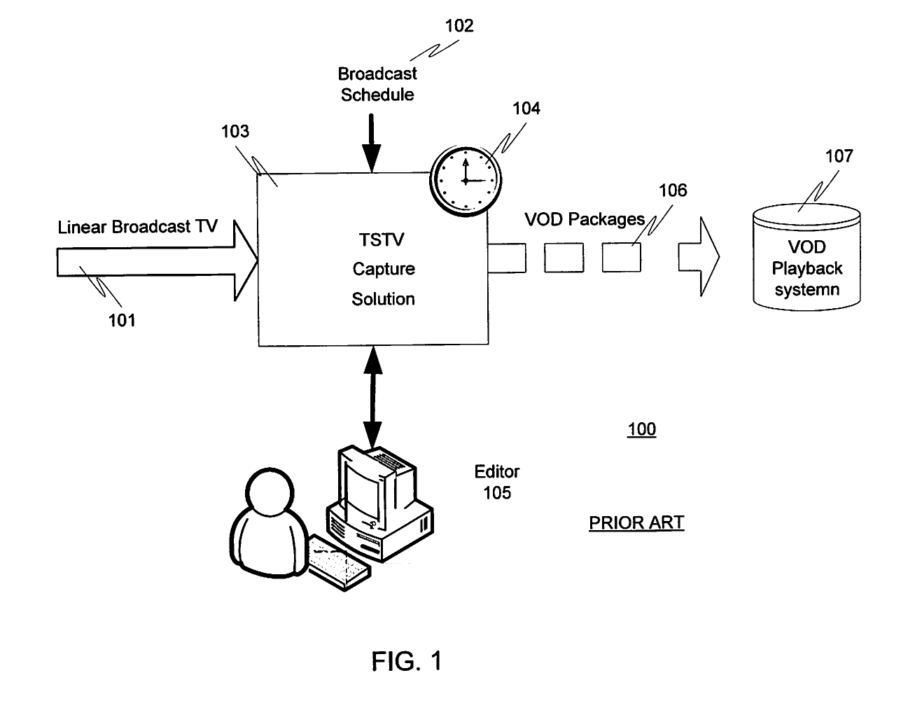

FIG. 2 shows a flow chart of the basic method for detecting linear broadcast adverts in TSTV assets captured off live linear broadcasts according to an embodiment of the present invention;

FIG. 3 shows a schematic block diagram of a linear broadcast advert detector apparatus according to an embodiment of the invention;

FIG. 4 shows an advert inventory generator apparatus according to an embodiment of the invention;

FIG. 5 shows the integration of the linear broadcast advert detector and advert inventory generator apparatus according to an embodiment of the invention;

FIG. 6 shows a more detailed flowchart of the method of detecting linear broadcast adverts and generating an advert inventory according to an embodiment of the invention.

### DETAILED DESCRIPTION

An embodiment of the invention will now be described with reference to the accompanying drawings in which the same or similar parts or steps have been given the same or similar reference numerals.

The digitally encoded broadcast channels are presented to the TSTV asset capture system, typically over Internet Protocol (IP) based communications links or Asynchronous Serial Interface (ASI). Equally, the resultant VOD packages are delivered back over the same or similar communications links.

Embodiments of the invention enhance time shifted and Networked Personal Video Recorder (N-PVR) applications by enabling the accurate replacement of personal adverts in the TSTV assets. They may also provide an accurate definition of programme boundaries, since adverts naturally delineate programmes.

A core function is the ability to detect advert slots within a live broadcast video feed and generate time code data to identify the position of the advert slots within the selected programme, and at either end. The captured data will then serve at least the following two purposes:

1) It will enable a downstream system to replace or remove the original broadcaster placed adverts automatically, as required, without the need for manual editing of the TSTV asset, which is time consuming and expensive to provision.

2) It will also enable a TSTV/VOD system to capture content on accurate program boundaries, thus removing the need for post-capture editing.

Although the present invention may equally apply to both analogue and digital TV broadcasting, the following detailed description will be cast in terms of digital TV broadcasting, since it is increasingly the most prevalent TV broadcasting type in the world today.

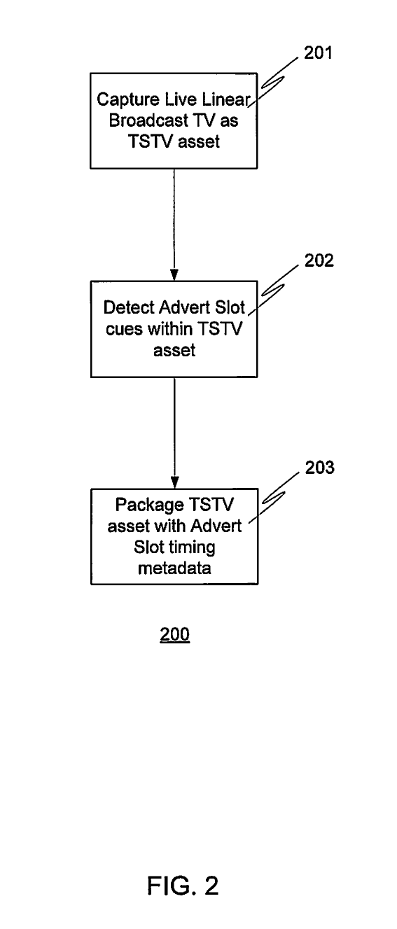

A method for detecting linear broadcast adverts 200 according to an embodiment of the present invention is shown in FIG. 2 in its simplest form, i.e. as a means to detect adverts within a linear TV broadcast so that the content of the advert slots can be replaced, or the respective TSTV assets can be played out advert free to an end viewer.

Live linear broadcast TV is captured, at step 201, to form raw TSTV assets. These raw TSTV assets are then analysed to detect the advert slot cues at step 202. This analysis provides advert slot timing metadata to a TSTV asset packager at step 203, which is then able provide a packaged up TSTV asset and associated advert slot timing information (time base code) in the form of appended metadata. Further metadata may also be included, as described in more detail below. By using the advert slot timing metadata, the downstream systems can play out the TSTV asset, with different adverts, or with adverts removed, as required.

The advert slot timing information is often referred to as an “ad avail”. The TSTV asset file and the associated metadata together form a “VOD Package”. VOD Packages may be transferred using a variety of protocols, typically over IP. An example of such a protocol is CableLabs™ Asset Distribution Interface (ADI).

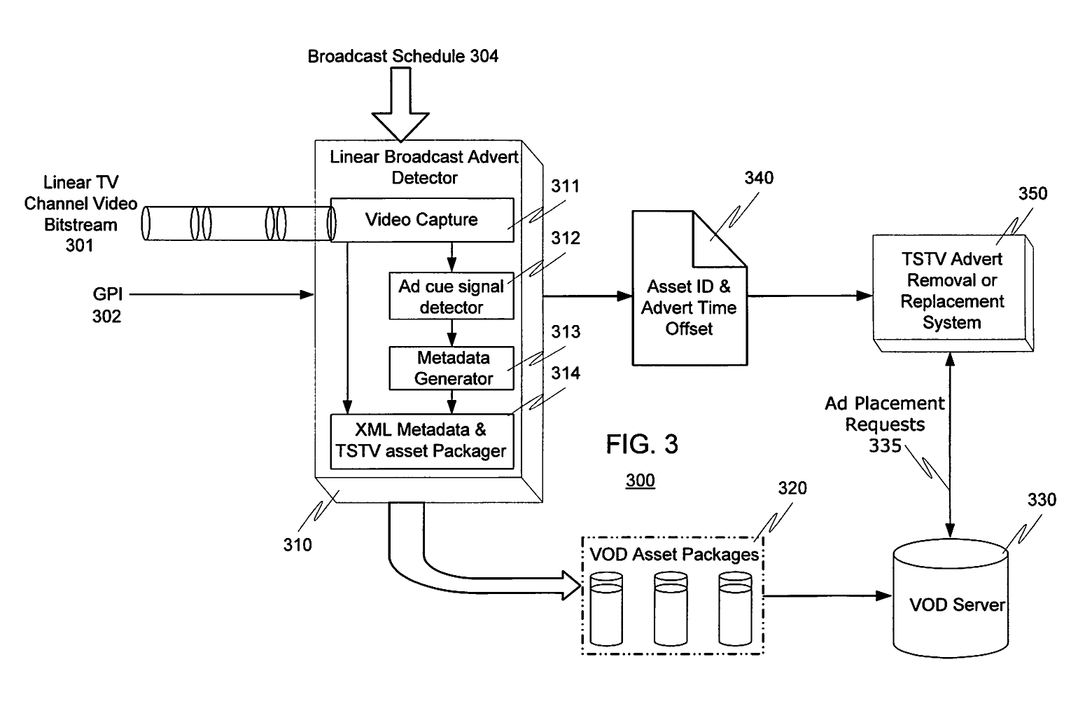

FIG. 3 shows a schematic block diagram of an embodiment of the linear broadcast advert detector, as integrated in a simple TSTV asset capture and playback system 300. The primary purpose of the linear broadcast advert slot detection in FIG. 3 is to enable removal or replacement of the adverts from the TSTV assets prior to playback.

Linear broadcast TV 301 and, if required, General Purpose Interface (GPI) contact closures signalling 302, are inputted into a linear broadcast advert detector 310. This is the new component that will analyse the incoming linear broadcast TV feed 301 to detect advert slot cue tones either within the feed or from an external source such as a GPI contact closure 302. The linear broadcast advert detector 310 may use the advert slot cue tone timing information both to trigger the capture of the content wanted for use in VOD offerings, and also create advert slot time code metadata that can be packaged up with the TSTV asset, for use by the downstream systems.

The linear broadcast advert detector includes a time code module (not shown) to provide time codes for the advert slots, relative to the TSTV asset length, or a pre-determined universal base time code. A standardised mechanism may be used to determine the absolute time from which other measurements are made, such as Network Time Protocol (NTP), to gain an accurate knowledge of the time and date from centralised and trusted Time Servers.

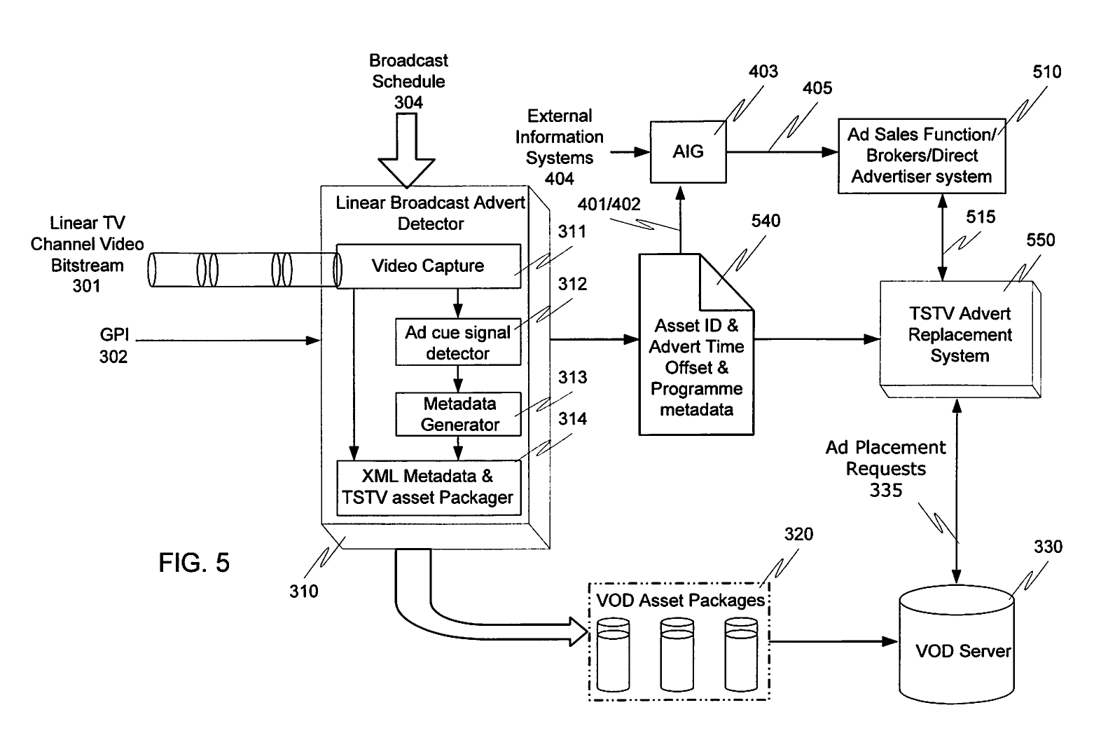

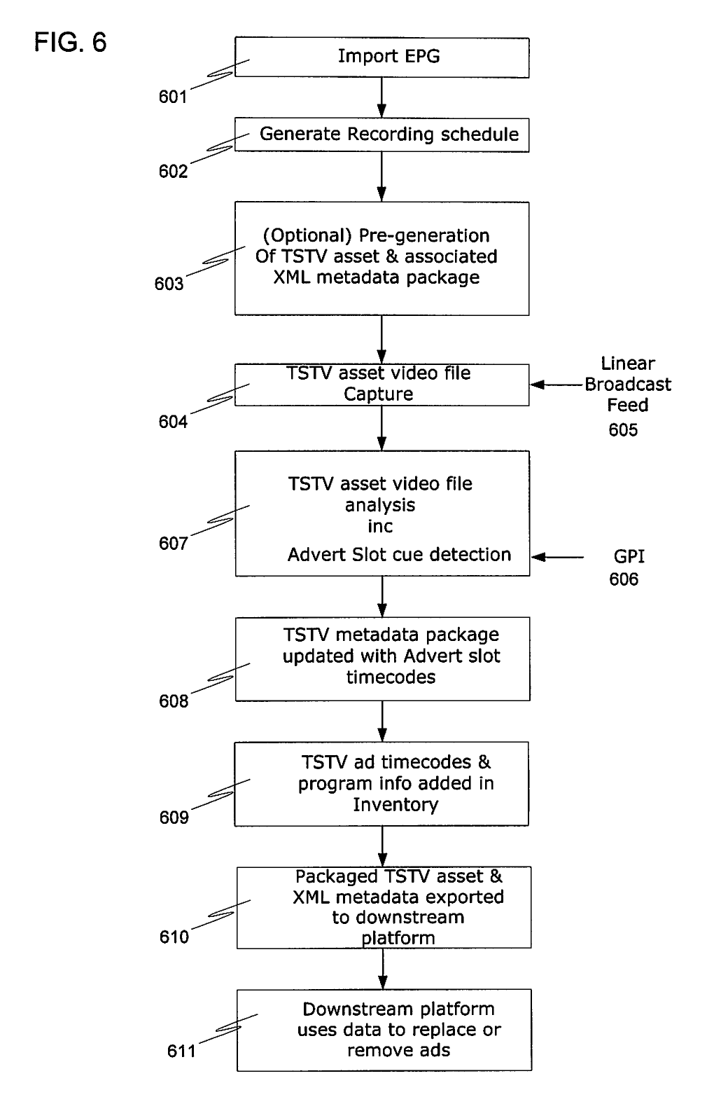

The linear broadcast advert detector 310 at least comprises: a video capture device 311, for capturing the TSTV/VOD content to be analysed; an advert cue signal detector 312, adapted to detect any known advert cue type, in order to derive advert slot timing information about advert slots within the captured TSTV asset; a metadata generator 313 to generate metadata including the advert slot timing information; and a data packager, such as XML and TSTV asset data packager 314, to package up the captured TSTV asset together with the metadata about the advert slot timings within the TSTV asset. As described in more detail below, with reference to FIGS. 5 and 6, the linear broadcast advert detector may have the broadcast schedule 304 inputted as a further source of programme metadata.

The linear broadcast advert detector 310 provides as an output both packaged TSTV assets 320, for storage in a VOD server 330 for later playback, and specific advert slot information about particular TSTV assets, for example in the form of an asset identification and advert slot time offset 340. This may then be used by a downstream VOD advert replacement/removal system 350, which is in communication 335 with the VOD server or other device which actually implements the advert removal/replacement.

The TSTV assets are typically stored to a data file, either locally to the capture device on storage means such as a hard disk, Redundant Array of Inexpensive Disks (RAID), flash memory or the like, or remotely on some networked storage means, such as an enterprise RAID array, Network Attached Storage (NAS) or the like. If the TSTV asset is initially stored locally, then once the advert slot analysis is complete, the TSTV asset may be moved to a central VOD server 330. Alternatively, the TSTV asset file may be analysed and transferred to a VOD server 330 in real-time.

In some embodiments, all the above functionality may be contained within the one device, which serves the purposes of capture, analysis and eventual TSTV asset delivery.

The TSTV asset capture system is typically capable of capturing multiple events simultaneously from multiple TV channels, through using multiple video input feeds/tuners and capture devices.

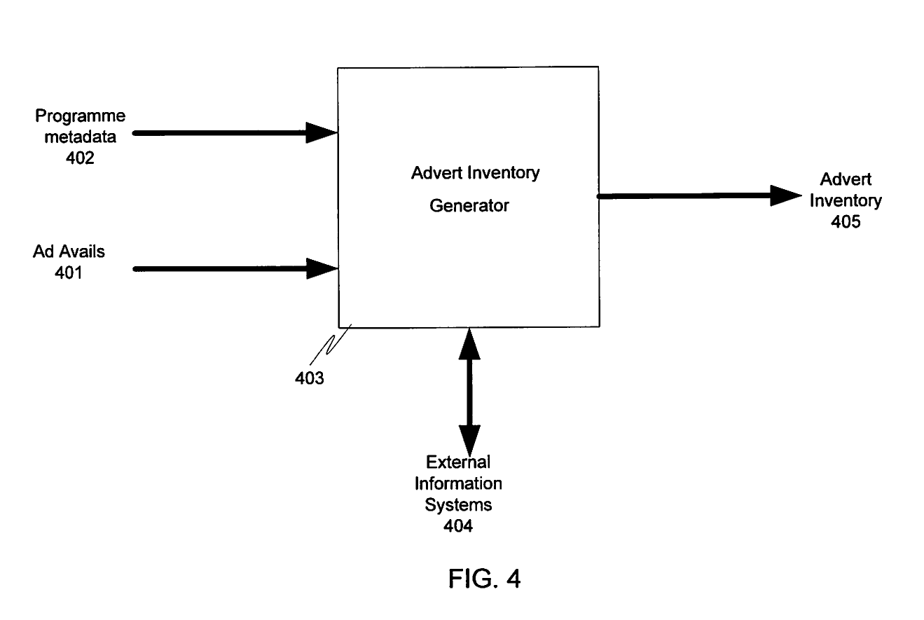

The linear broadcast advert detector may be integrated with an advert slot inventory generator 403, as shown in FIG. 4, which aggregates all the information available on every TSTV asset being inputted into a VOD playback system, as a form of overall inventory of the TSTV assets. This TSTV asset inventory can then be used to sell the advert slots available for replacement in the TSTV assets. In this case, the XML packager of the linear broadcast advert detector will also include information on the captured TSTV asset derived from the broadcast schedule, which is required to characterise the advert slots to advertisers. This is to say, by combining the two devices, a much more capable VOD adverts characterisation system is produced, which facilitates replacement advert sales.

The advert slot inventory generator (AIG) 403 may be an integrated element of a TSTV asset capture system or it may be a separate component for integration into a modified existing VOD system, where a basic metadata generator module may already exist to create package metadata about the captured program for individual VOD packages from the broadcast schedule alone. In this case, the linear broadcast advert detection module passes advert slot time code data to the existing metadata generator module to include the ad avail time code information as an additional data set within the TSTV asset package.

The AIG 403 uses the TSTV asset capture system to create a TSTV asset from the linear broadcast stream, including a list of ad avails 401 for each TSTV asset captured, as discussed above, and additionally to capture and package programme metadata (information about the captured TSTV asset from the Broadcast Schedule), both of which may be used by the AIG 403 to create an ad inventory 405.

The key information provided in the ad inventory 405 is the number and type (pre-roll, post-roll, interstitial) of ad avails and the genre of the associated content (from the broadcast schedule). This information allows existing advertising linear advertising solutions to market the TSTV/VOD ad slots.

Optionally, additional information can be added to the inventory from external sources 404 (such as the internet website related to the captured programme, or a 3^{rd} party organisation that provides viewing statistics which may affect the value of an ad slot—e.g. viewing figures for the same program when broadcast live), or from additional information provided in the Broadcast Schedule. The Ad Inventory Generator 403 could, for example, query external web sites to gather additional information (such as popularity ratings, box office takings, etc) and add that to the advert inventory 405.

The following table gives an example of the types of information that may be provided in the ad inventory 405:

| Data | Comments |
|---|---|
| Title | Title of the TSTV asset |
| Description | Optional. Textual description of the asset (could be |
| | used to facilitate placement against advertising |
| | keywords) |
| Genre | Genre, as classified by the content owner, |
| | aggregator or operator |
| Category | Optional. Category in which the TSTV asset will be |
| | displayed in the VOD catalogue |
| Availability | Dates when the TSTV asset will be available for |
| Window | viewing |
| Rating | Rating/Certification. May be used to restrict |
| | content to post-watershed, for example |
| Avail | One entry per avail |
| Specification | Timecode of in point (start of avail) |
| | Timecode of out point (end of avail) |
| | Duration of avail |
| | Type of avail (pre-roll, post-roll, interstitial) |

Additional information could be included. For example, the AIG 403 could query an external system to obtain the demographic classification for the likely audience of the respective TSTV asset and include this information in the ad inventory.

A complete advanced TSTV asset capture and playback system including both the linear broadcast advert detector system and the AIG is shown in FIG. 5. This figure is largely the same as FIG. 3, but now further comprises the AIG 403, which takes the XML metadata as an input 401/402 (which includes both the programme data and the advert slot timing data 540), as well as external information system data 404, and generates an Advert Inventory, which feeds into the advert sales function 510. The advert sales function then directs the replacement of adverts within the TSTV assets, according to sales made using the advert inventory, by messages 515 sent to the advert replacement system 550

A more detailed embodiment of the method for detecting linear broadcast adverts 600 and providing an advert inventory according to the present invention is shown in FIG. 6.

At step 601, the method commences with the definition of a capture schedule, which defines which programmes, on what channels, should be recorded at certain times. This process typically involves importing the Electronic Program Guide (EPG) or other broadcast schedule into the TSTV asset capture system. The schedule typically includes details of the programmes for broadcast, including TV channel, programme title, summary, start and end time, genre, category, brief synopsis, age certification, and the like. This data helps categorise the type of viewer expected to watch a particular programme (e.g. a car show may imply a young—middle age male audience, and a kid's cartoon may imply children or mothers watching).

At step 602, a recording schedule is generated using an import of broadcast programme data against the main broadcast schedule. The recording schedule may also be generated by a high level manual review of the broadcast schedule to select TSTV asset content that is likely to be popular, which can then be captured, and whose advert slots tagged, etc, automatically. Alternatively, rules might be established in the TSTV asset capture system to record certain events automatically, or there may be data in the broadcast schedule that indicates whether or not an event may be recorded.

An optional step 603 of pre-generating TSTV asset package metadata from the broadcast schedule/EPG may take place, especially if the TSTV asset is exported to the VOD platform in real time.

The generated recording schedule is used to control when to start and stop recording of TSTV assets from the linear broadcast feed 605 (optionally via detecting a GPI signal, 606) at step 604, which creates the basic TSTV asset data files which can then be combined with the associated XML programme metadata. The live linear broadcast feed arrives at a head end (i.e. broadcast input).

At step 606, the TSTV asset capture system analyses the input broadcast stream for advert slot positions, looking for commonly used advert slot identifiers, including but not limited to:
a. SCTE-35 messages.
b. Dual-Tone Multi-Frequency (DTMF) cue tones.
c. High/low frequency audio cue tones.
d. High/low volume audio cue tones.
e. Visual cues, e.g. IBA (Independent Broadcasting Authority) cue mark
f. External triggers such as GPI contact closures 606 (i.e. physical external switching).
g. VANC (Vertical Ancilliary Data Space).
h. Other signals or communications as agreed between the broadcaster and the turn around operator.

This analysis may be carried out in real-time, or as a post capture processing step. The TSTV asset capture system identifies a programme boundary through the advert slot cues (e.g. the pre-roll advert cues before a programme) and starts to capture the video bit stream. Alternatively, the whole channel may be constantly captured, with the TSTV asset capture system using a separate analysis step to detect the advert slot cue tones in order retrospectively to divide the captured material into separate TSTV assets (i.e. programmes) with documented advert slots.

At step 608, TSTV asset capture system creates TSTV asset XML metadata using data from multiple sources, including but not limited to:
a. the EPG or broadcast schedule;
b. External System Information (SI) data such as that defined by Digital Video Broadcast (DVB) standards;
c. Advert slot position timecode data.

The TSTV asset package is updated with the new information, if pre-generation has been carried out, or the complete TSTV asset XML metadata file is created at this point.

At step 609, the TSTV asset capture system exports the TSTV asset XML metadata portion of the TSTV asset package into the advert inventory generator 403 as described above, so that this particular TSTV asset can be added to the inventory of available assets 405 with replaceable advert slots. The updated inventory 405 is made available to the advert slot sales function 510 (which may be any of: a direct sales system, broker or linkages to advertisers directly) through a link from the AIG 403. The advert slot sales results are fed back to the advert replacement system via a similar link, in order to carry out the required advert replacement.

Instead of a direct link, the advert sales function may be indirectly linked (not shown) to the actual advert replacement system, by mutually indexing a communal database of advert placings. In this way, adverts are served up with respective TSTV assets in a desirable order, but without requiring constant input from the advert sales function (i.e., it allows asynchronous update of the advert slots replacement timetable).

The complete TSTV asset package 320 (i.e. the XML metadata and the respective TSTV asset) is then exported to downstream VOD platform components, such as the VOD delivery platform (VOD server 330) and advert replacement system 550, at step 610, for eventual use by these downstream systems at step 611.

In some embodiments, as well as the XML metadata containing the advert slot timing data, the actual TSTV assets may be converted to use modern up to date digital advert cue signals, such as SCTE-35 messages, as opposed to the previously found legacy cue signals, such as audio cue signals.

An exemplary use of the advert inventory is detailed below.

The advert replacement system acknowledges receipt of each TSTV asset and XML metadata package received. They may be received individually, or as a de-lineated bit stream. The packages include the TSTV asset itself, and information about the TSTV asset, such as advert slot time codes for the advert slots contained in the pre-programme adverts portion, the interstitial adverts portion, and the post-programme advert portion. Also included is other programme data, such as programme type, original broadcast time and date, viewer age certification, number of ad slots, etc. The advert placement plans are at least partly based on the XML metadata package, but may also include data from past viewing figures supplied by third party organisations, advertisers or brokers.

The VOD playback system delivers video streams to unique customers at their specific request. Each stream is unique to a particular end viewer/customer, the characteristics of whom is also known to the VOD system. These further pieces of important information (from the point of view of advertisers wishing accurately to target adverts) may be utilised in conjunction with the metadata provided together with the TSTV asset. The VOD system requests advertisement playlists from the advert replacement system in the event that the requested content is advert enabled.

The advert replacement system uses advertising campaign rules and the available TSTV asset inventory to create an advertisement playlist in response to each request from the VOD playback system platform. The inclusion of advert slot time code data in the program metadata allows the VOD system both to identify that the content is advert enabled and to determine where to place the replacement ads.

The VOD playback system recognises that a particular piece of VOD content is enabled by the receipt of a TSTV asset package. The advert replacement system and advertising slot sales function are both similarly informed of the availability of a particular piece of VOD content, with the XML metadata providing not only absolute timings of the advert slots available, but also a more detailed viewer characterisation of the advert slots, which improves the marketability of the advert slots. Alternatively, the TSTV asset can now be stripped of advertising automatically and on the fly.

When an end viewer selects to view a particular piece of advert enabled VOD/ TSTV content through the VOD playback platform, the VOD playback platform, such as VOD server, will request suitable, up to date adverts from the advert placement system, which have been sold to advertisers based on the complete programme metadata provided during capture, as well as information on the specific user. There may also be optional conditional parameters used, such as if the program is played back at a certain time, one particular advertisement will be used, whereas if the same program is played back at another substantially different time, then a second advertisement may be used. The advert placement system is basing its provisioning plans on the known characteristics of the ad slots in relation to the associated programming and consumer viewing habits.

The advert replacement system responds with a playlist of suitable adverts to play out in replacement of the original adverts. The VOD playback system plays out the TSTV asset with ads removed or with ads replaced according to the requirements laid out in the TSTV asset playlist.

The above described method may be carried out by any suitably adapted or designed TSTV/VOD hardware. Portions of the method may also be embodied in a set of instructions, stored on a computer readable medium, which when loaded into a computer, Digital Signal Processor (DSP) or similar, causes the computer to carry out the hereinbefore described method.

Equally, the method may be embodied as a specially programmed, or hardware designed, integrated circuit which operates to carry out the method for TSTV asset capture and characterisation loaded into the said integrated circuit. The integrated circuit may be formed as part of a general purpose computing device, such as a PC, and the like, or it may be formed as part of a more specialised device, such as a video server, distributed advertising sales function or the like.

One exemplary hardware embodiment is that of a Field Programmable Gate Array (FPGA) programmed to carry out the described method and /or to provide the described apparatus, the FPGA being located on a daughterboard of a rack mounted video server held in a data centre, for use in, for example, a I PTV television system and/or, content aggregator/operator content delivery platform.

It will be apparent to the skilled person that the exact order and content of the steps carried out in the method described herein may be altered according to the requirements of a particular set of execution parameters, such as type of information needing capture, and the like. Furthermore, it will be apparent that different embodiments of the disclosed apparatus may selectively implement certain features of the present invention in different combinations, according to the requirements of a particular implementation of the invention as a whole. Accordingly, the claim numbering is not to be construed as a strict limitation on the ability to move features between claims, and as such portions of dependent claims maybe utilised freely.

1.-22. (canceled)

23. A method of removing or replacing advert slots in linear broadcast television programming when replayed as a time-shifted television asset, comprising:
capturing an input linear broadcast video stream to form a time-shifted television asset;
detecting advert cue signals indicative of advert slot timings within the time-shifted television asset;
generating metadata indicative of the advert slot timings from the detected advert cue signals; and
packaging the time-shifted television asset together with the metadata, for use by a down stream system to replace or remove adverts from the time-shifted television asset.

24. The method of claim 23, wherein the advert cue signals include anyone or more of:
a. SGTE-35 messages
b. Dual-Tone Multi-Frequency (DTMF) cue tones
c. High/low frequency audio cue tones
d. High/low volume audio cue tones
e. Visual cues, e.g. IBA (Independent Broadcasting Authority) cue mark
f. External triggers such as GPI contact closures (Le. physical external switching)
g. VANG (Vertical Ancilliary Data Space)
h. Other signals or communications as agreed between the broadcaster and a turn around operator

25. The method of claim 23, further comprising:
removing adverts prior to or at the time of playback of the time-shifted television asset to an end viewer, dependent upon the metadata generated from the detected advert cue signals.

26. The method of claim 23, further comprising:
replacing an original advert with one or more alternative adverts, prior to or at the time of playback of the time-shifted television asset to an end viewer dependent upon the metadata generated from the detected advert cue signals.

27. The method of claim 23, wherein the metadata is XML metadata, and the metadata further includes programme characterisation information derived from a broadcast schedule associated with the linear broadcast television programming.

28. The method of claim 23, wherein the advert slot timings are outputted as SCTE 35 messages accompanying the time-shifted television asset.

29. The method of claim 23, wherein the step of capturing an input linear broadcast video stream further comprises:
importing a broadcast schedule; and
generating a capture timetable from the imported broadcast schedule.

30. The method of claim 29, wherein the step of generating metadata indicative of the advert slot timings from the detected advert cue signals further comprises:
pre-generating metadata from the imported broadcast schedule prior to capture of the broadcast stream, indicative of programme data excluding advert slot timings; and
updating the pre-generated metadata with metadata indicative of the detected advert cue signals after detection.

31. The method of claim 23, further comprising:
generating a time-shifted advert inventory characterising each advert slot available within each time-shifted television asset available for playback within a Video-On-Demand playback system.

32. A time-shifted television asset capture device, comprising:
a linear broadcast video stream input;
an advert cue signal detector to detect advert cue signals;
a metadata generator adapted to generate metadata from the detected advert cue signals; and
a metadata and time-shifted television asset packager adapted to package the metadata and time-shifted television asset together for delivery to a downstream system.

33. The time-shifted television asset capture device of claim 32, wherein the capture device is adapted to carry out a method of removing or replacing advert slots in linear broadcast television programming when replayed as a time-shifted television asset, comprising:
capturing an input linear broadcast video stream to form a time-shifted television asset;
detecting advert cue signals indicative of advert slot timings within the time-shifted television asset;
generating metadata indicative of the advert slot timings from the detected advert cue signals; and
packaging the time-shifted television asset together with the metadata, for use by a down stream system to replace or remove adverts from the time-shifted television asset.

34. The time-shifted television asset capture device according to claim 32, further comprising a GPI contact input.

35. A computer-readable medium, carrying instructions, which, when executed, causes computer logic to carry out a method of removing or replacing advert slots in linear broadcast television programming when replayed as a time-shifted television asset, comprising:
capturing an input linear broadcast video stream to form a time-shifted television asset;
detecting advert cue signals indicative of advert slot timings within the time-shifted television asset;
generating metadata indicative of the advert slot timings from the detected advert cue signals; and
packaging the time-shifted television asset together with the metadata, for use by a down stream system to replace or remove adverts from the time-shifted television asset.

36. A method of producing an inventory of advert slots within a collection of time-shifted television assets, comprising:
receiving data about a content of a captured time-shifted television asset within the collection of time-shifted television assets;
combining the received data into a predetermined structure with data on other time-shifted television assets within the collection of time-shifted television assets; and
outputting an updated advert slot inventory in a predetermined data structure to a downstream system.

37. The method of claim 36, wherein the step of receiving data about content of a captured time-shifted television asset further comprises:
receiving a programme information data portion, providing details of a programme contained within a time-shifted television asset, including one or more of: a title of the TSTV asset;
a genre, as classified by the content owner, aggregator or operator;
a date range when the TSTV asset will be available for viewing;
an age certification of the TSTV asset; and
an advert slot timing information portion.

38. The method of claim 37, wherein the advert slot timing portion comprises anyone or more of:
timecode of a start point of an advert slot;
timecode of an end point of an advert slot;
duration of an advert slot;
type of an advert slot, wherein the type comprises anyone of pre-roll, post-roll or interstitial.

39. The method of claim 36, wherein the step of receiving data about content of a captured time-shifted television asset further comprises receiving data from an external information source about the time-shifted television asset.

40. A time-shifted television advert slot inventory generator adapted to generate an inventory of advert slots available in a catalogue of time-shifted television assets, including characterisations of a type of time-shifted television asset, for use by a downstream system, comprising:
an input for receiving data on captured time-shifted television assets;
a processor to combine received data on captured time-shifted television assets into a predetermined data structure; and
an output for exporting a completed advert inventory in a predetermined data structure to a downstream system.

41. The time-shifted television advert slot inventory generator of claim 40, wherein the input for receiving data on captured time-shifted television assets further comprises:
a programme information data portion, providing details of a programme contained within a time-shifted television asset, including one or more of:
a title of the TSTV asset;
a genre, as classified by the content owner, aggregator or operator;
a date range when the TSTV asset will be available for viewing;
an age certification of the TSTV asset; and
an advert slot timing information portion.

42. The time-shifted television advert slot inventory generator of claim 40, wherein the input for receiving data on captured time-shifted television assets further comprises an external information system input, for receiving data on time-shifted television assets from systems external to a time-shifted television asset playback system.

43. The time-shifted television and advert slot inventory generator of claim 40, wherein a downstream system is a sales function, time-shifted television server or time-shifted television advert replacement system.
